(19) United States
(12) Patent Application Publication
(10) Pub. No.: US 2025/0066246 A1
(43) Pub. Date: Feb. 27, 2025

(54) THE CARBON DIOXIDE FIXING SLUDGE FINE POWDER, ITS PRODUCTION METHOD AND HYDRAULICALLY HARDENED BODY

(71) Applicants: SANWASEKISAN CORPORATION, Fujisawa-shi, Kanagawa (JP); KAJIMA Corporation, Tokyo (JP)

(72) Inventors: Ken OHKAWA, Fujisawa-shi (JP); Shinichi AOKI, Fujisawa-shi (JP); Haruki MOMOSE, Tokyo (JP); Shiro TOMOE, Tokyo (JP); Tetsushi KANDA, Tokyo (JP); Kazuhisa YODA, Tokyo (JP); Hiroshi KASAI, Tokyo (JP); Noboru SAKATA, Tokyo (JP)

(73) Assignees: SANWASEKISAN CORPORATION, Fujisawa-shi, Kanagawa (JP); KAJIMA Corporation, Tokyo (JP)

(21) Appl. No.: 18/725,387

(22) PCT Filed: Jan. 6, 2023
(86) PCT No.: PCT/JP2023/000207

§ 371 Date: Jun. 28, 2024

(30) Foreign Application Priority Data
Jan. 20, 2022 (WO) PCT/JP2022/001938

(51) Int. Cl. C04B 18/167; B09B 3/29; B09B 3/35; B09B 3/40; B09B 101/45; C04B 20/10; C04B 28/02

(52) U.S. Cl. CPC C04B 18/167; B09B 3/29; B09B 3/35; B09B 3/40; C04B 20/107; C04B 28/02; B09B 2101/45

(57) ABSTRACT

A production method of carbon dioxide fixing sludge fine powder as a low-carbon binder. Water is added to residual concrete or returned concrete to form it into a slurry, gravel and sand are separated and removed therefrom, fine sand is separated and removed from the sludge water by a wet cyclone to obtain concentrated sludge water, and the concentrated sludge water is dehydrated to obtain a sludge cake. The sludge cake is put into a rotary drum, hot air and highly concentrated carbon dioxide are supplied into the rotary drum, the carbon dioxide is fixed and is crushed and dried to obtain carbon dioxide fixing sludge fine powder. Alternatively, the sludge cake is crushed and fractured to obtain sludge fine powder. This sludge fine powder is exposed to highly concentrated carbon dioxide to obtain carbon dioxide fixing sludge fine powder.

### TECHNICAL FIELD

The present invention deals with a production method of fine powder to be utilized as a binding material by subjecting a sludge cake to a predetermined treatment. The sludge cake is a recovery of residual concrete or returned concrete where aggregates and fine sand are removed except for unhydrated cement components. The invention also includes the resulting fine powder, and the hydraulically hardened body using the fine powder as a binder.

### BACKGROUND TECHNOLOGY

Concrete, mortar and the like to be placed in construction sites are manufactured in ready-mixed concrete plants, and are then delivered with agitator trucks. Concrete which is not used in the construction side or fails an acceptance inspection are returned to the plant as so-called residual concrete or returned concrete, and it is reported that such rejected concrete reaches 2 to 3% of the entire concrete. Such rejected concrete is conventionally processed as an industrial waste, but it needs to be effectively utilized to avoid the significant processing cost and the environmental load.

In recent years, reduction of carbon dioxide emission has been required in various industrial areas for preventing the global warming. In the cement manufacturing industry, the amount of carbon dioxide emission occupies about 4% of the entire Japanese emission, and cement production with high-temperature firing is particularly large with carbon dioxide emissions intensity of 766 kg/ton. To suppress the amount of carbon dioxide emission, development of technologies capable of reducing the use of cement or replacing cement with alternative binder with lower carbon content are anticipated.

### PRIOR ART DOCUMENTS

### Patent Documents

[Patent Document 1] Japanese Patent No. 4472776
[Patent Document 2] Japanese Patent No. 6811521
[Patent Document 3] Japanese Patent Application Laid-open No. H5-238790

In the patent document 1, a method for collecting sludge fine powder with a large portion of unhydrated cement from residual or returned concrete is described. First, water is added to the residual concrete or the returned concrete to form a slurry, removing gravel and sand, and then fine sand is removed by a wet cyclone to obtain sludge water. Next, the sludge water is removed to obtain dehydrated cake, which is then placed in a rotary drum, subjected to a high temperature air and simultaneous operation of crushing and drying are carried out. Since crushing and drying operation is carried out simultaneously, it is possible to suppress the development of hydration reactions, and to obtain excellent sludge fine powder with a high unhydrated cement content. As proposed in the patent document 2 for example, the sludge fine powder can be utilized as a binder by which a portion of cement can be replaced.

In the patent document 3, methods to obtain finely divided powder from the screened waste sludge of concrete plants or from the demolished concrete, and to fix carbon dioxide gas in the fine powder are described to obtain a cement filler. Before carbonation treatment, the finely divided powder shows a high water absorption rate and deteriorate the concrete workability. However, if the finely divided powder is processed in carbon dioxide gas and carbonated, a cement filler without harmful effects on the concrete workability can be obtained.

### SUMMARY OF THE INVENTION

### [Object to be Solved by the Invention]

The sludge fine powder described in the patent document 1 is obtained from the residual concreate or the returned concrete as a waste material and fuel consumption during the crushing-drying operation is small, so it is a binder of low carbon dioxide emission. When replacing a portion of cement with the sludge fine powder as an alternative binder, the resulting hydraulically hardened body will be able to suppress the amount of carbon dioxide emission. The more the sludge fine powder is used, the more the carbon dioxide emissions can be reduced, while it also causes a decrease in workability (fluidity) of the slurry.

Cement filler described in the patent document 3 can be utilized without sacrificing the workability of concrete. In addition, capability of carbon dioxide fixation can contribute to suppression of the amount of carbon dioxide emission. However, the cement filler described in the patent document 3 cannot be expected as a binder. When partially replacing the cement and used for a hydraulically hardened body, the replacement ratio is not large. In the method to collect the finely divided powder from the sludge described in the patent document 3, finely divided powder is taken out only by screening the sludge, and fine sand cannot be removed substantially. Because the cement content in the finely divided powder is small, the fraction of the fine sand and the cement is unclear, and hence the mix design obtaining the required strength cannot be determined, use of the finely divided powder as the binder is difficult.

Further, in the finely divided powder described in the patent document 3, unhydrated cement content in the cement portion is not clear and there is no description how to dry the finely divided powder probably assuming a general processing method. In the general processing method, the finely divided powder is obtained first by dehydrating the sludge to obtain dehydrated cake which is then subjected to drying followed by crushing processes, where the crushing and the drying operations are not simultaneously carried out. If the finely divided powder is obtained in such a method, hydration reactions may proceed and unhydrated cement content in the entire cement naturally becomes small. As described in a paper “A Study on the Degree of Activity and Utilization for Dried Granulated Concrete Sludge” (Cement Science and Concrete Technology, No. 51, 470-475, 1997 [in Japanese]), the final concrete strength cannot be obtained when a finely divided powder produced by general method is utilized as a binder. it is substantially difficult to utilize the finely divided powder described in patent document 3 as a binder. Further, the finely divided powder described in the patent document 3, the it was added about 5% in concrete having less contribution on the reduction of carbon dioxide emission.

The present invention provides a production method of carbon dioxide fixing sludge fine powder which can be used as a binder capable of suppressing the amount of carbon dioxide emission, reusing the residual or returned concrete.

### Means for Solving the Problem

The invention provides a method to obtain carbon dioxide fixing sludge fine powder with a high unhydrated cement content from residual concreate or returned concrete. More specifically, water is added to the residual concrete or the returned concrete to form a slurry. Then, gravel and sand are removed from the slurry to obtain sludge water, fine sand is removed from the sludge water by a wet cyclone to obtain concentrated sludge water, and the concentrated sludge water is dehydrated to obtain a sludge cake. The sludge cake is put into a rotary drum and subjected to crushing-drying under hot air and highly concentrated carbon dioxide to obtain the carbon dioxide fixing sludge fine powder. Alternatively, the sludge cake is put into the rotary drum and subjected to crushing-drying under hot air to obtain sludge fine powder. it is then exposed to highly concentrated carbon dioxide to obtain the carbon dioxide fixing sludge fine powder. The sludge fine powder before the carbon dioxide fixation must have unhydrated cement with an area fraction more than 0.5 over the entire sludge fine powder.

### [Impacts of the Invention]

This invention provides a binder capable of reducing carbon dioxide emission. The carbon dioxide fixing sludge fine powder produced by the invention shows better workability than that without carbon dioxide fixing.

### BRIEF DESCRIPTION OF THE DRAWINGS

FIG. 1 is a flowchart showing a production method Case 1 to obtain the carbon dioxide fixing sludge fine powder.

FIG. 2 is a flowchart showing a production method Case 2 to obtain carbon dioxide fixing sludge fine powder.

FIG. 3 is a microscope image of sludge fine powder before carbon dioxide fixation.

FIG. 4 shows a relationship between specific surface area of the sludge fine powder and area fraction of unhydrated cement.

FIG. 5 shows a relationship between temperature in a container and mortar flow value when carbon dioxide fixation proceeded by sludge fine powder for a certain period of time.

### STEPS FOR CARRYING OUT THE INVENTION

### Production Method of Carbon Dioxide Fixing Sludge Fine Powder According to a First Embodiment

A production method of carbon dioxide fixing sludge fine powder as the first step of an embodiment will be described.

Concrete is produced by mixing the ordinary portland cement, aggregate such as gravel and sand, water and admixture by a forced mixer. Concrete produced in this manner is transported to a construction site and placed, while in some cases, a portion of the concrete remains unused or rejected in the acceptance inspection. Such concretes are returned to the ready-mixed concrete plant as residual concreate or returned concrete, or sent to another processing facility. Such residual or returned concrete is processed to produce carbon dioxide fixing sludge fine powder.

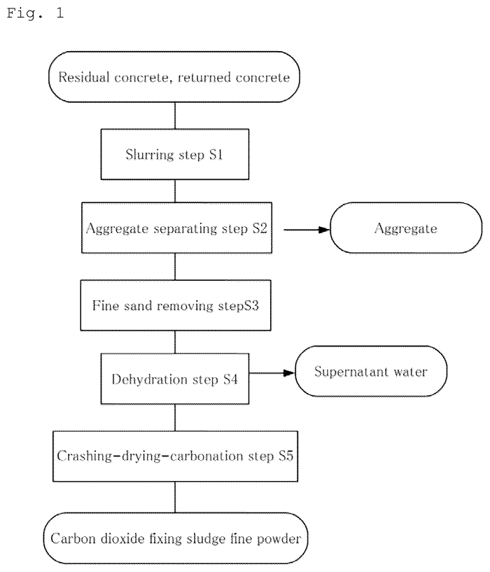

As shown in FIG. 1, the residual or returned concrete is subjected to a slurring by adding water as the step S1, where cement portion is sufficiently mixed with the added water. The slurry may include washout of the drum of agitator truck or may include washout that of a ready-mixed concrete plant.

Next, solid content such as aggregate to be removed from the slurry obtained in the step S1 is carried out as the step S2 using a plurality of vibrating sieves with different sieve sizes. The slurries are sequentially processed to separate the aggregate such as gravel and sand. The recovered aggregate can be reused. What was passing through the sieve is a sludge water with a high cement content. After the aggregate separating step S2, fine sand removing step S3 is carried out using a wet cyclone to remove fine sand from the sludge water. As a result, a concentrated sludge water is obtained and then processed in a next dehydration step S4. However, if the cement content of the concentrated sludge water is small, the sludge water can be sent to the previous step S1 and reused as a water slurring with residual concrete or returned concrete. According to this, cement content of the sludge water is increased. The concentrated sludge water is subjected to the dehydration step S4 and is processed by a filter press to obtain a sludge cake. At that time, a supernatant water is also obtained and can be reused as mixing water of concrete.

In the production method of the embodiment 1, the sludge cake is subjected to crashing-drying and carbon dioxide fixing as the step S5. Any device may be used as far as the supply of the highly concentrated carbon dioxide and the crushing-drying operation can be simultaneously applied to a sludge cake. However, this embodiment uses a predetermined rotary drum capable of efficiently carrying out the crushing-drying operation and of fixing carbon dioxide. The rotary drum is provided with a crushing-stirring blade which rotates therein at high speed and hot air and highly concentrated carbon dioxide can be supplied. Concentration of carbon dioxide in the rotary drum is set to 0.05 or higher or 0.9 or lower by volume fraction to air. Temperature is set to 50° C. (degree Celsius) or higher and 400° C. or lower. When a sludge cake is processed in the rotary drum, the sludge cake is crushed by the crushing-stirring blade, and the sludge cake fixes carbon dioxide during drying with the hot air and the carbon dioxide-fixing sludge fine powder is produced. Because in step S5, the crashing-drying and carbon dioxide fixing for the sludge are substantially and simultaneously carried out, it is possible to suppress the development of cement hydration reactions and to obtain carbon dioxide fixing sludge fine powder having a large amount of unhydrated cement.

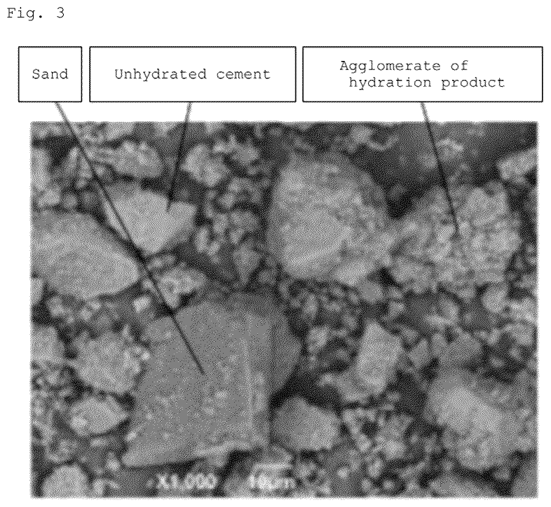

The sludge cake processed by the crashing-drying and carbon dioxide fixing of the step S5 needs to have predetermined quality, which is based on another quality of products obtained under different process conditions. In an actual case, the sludge cake is processed by the above-described step S5 processes, but this condition is condition of quality of sludge fine powder which is expected to be provided if the sludge cake is processed in another method. In processing carried out under another conditions, the above-described rotary drum is used, while carbon dioxide is not supplied to the rotary drum, and only high temperature air is supplied. If a sludge cake is crushed and dried without supplying the carbon dioxide in this condition, a sludge fine powder is supposed to be obtained anyway. The sludge fine powder obtained in this condition is shown in a microscope image of FIG. 3. This microscope image is evaluated in a paper “Development of Ready-Mixed Concrete with Dehydrated Sludge Powder,” (Kajima Technical Research Institute, Annual Report, No. 66, 75-84, 2018 [in Japanese]) Although a small amount of fine sand can be seen in the sludge fine powder, the majority is composed of unhydrated cement or agglomerates of cement hydrates.

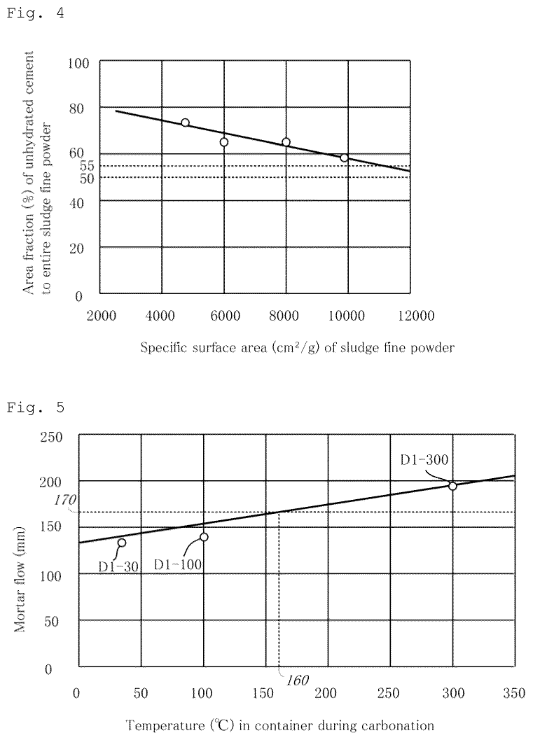

In this paper, a graph as shown in FIG. 4 is also explained. When the sludge fine powder is molded with resin and cut to expose a section, the area fraction of respective materials can be analyzed. In FIG. 4, concerning various sludge fine powders having different specific surface areas, the area fraction of unhydrated cement is analyzed and plotted in the graph. The specific surface area mentioned here is measured by the Blaine's permeation device which is specified in JIS R 5201 “Physical Testing Methods for Cement.” This method is a test to derive a specific surface area of powder from flow of air based on a hypothesis that “in powder bed made of spherical powder, an entire inner area of a passage through which gas passes air existing therein is equal to an entire surface area of the powder, and an entire volume of the passage is equal to a void volume”.

When this test is applied to the sludge fine powder, air passes through the porous agglomerate such as hydration products existing around the cement during the test, and the Blaine's specific surface area increases. Therefore, as the agglomerate of the hydration products of the sludge fine powder is larger, or as the amount of unhydrated cement is smaller, the specific surface area becomes larger. As shown in the graph, in the sludge fine powder which can be utilized as a binder, area fraction of unhydrated cement becomes 0.5 or more. At this time, a fact that the Blaine's specific surface area is 12,000 cm²/g or less is guaranteed, and the area fraction of unhydrated cement is high. Especially if the area fraction of unhydrated cement is more than 0.55, the Blaine's specific surface area becomes 11,000 cm²/g or less, and a ratio of the unhydrated cement becomes high. Thereupon, in the producing method of the embodiment, in the case of the sludge cake which is processed by the crashing-drying and carbon dioxide absorbing step S5, when a sludge cake is crushed and dried and sludge fine powder is obtained, the area fraction of unhydrated cement is 0.5 or more with respect to the entire sludge fine powder, and more preferably, 0.55 or more.

### Production Method of Carbon Dioxide Fixing Sludge Fine Powder According to Embodiment 2

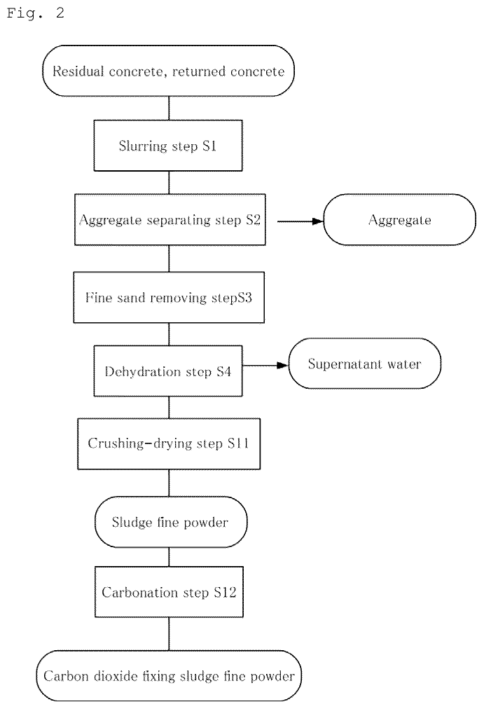

A production method of carbon dioxide fixing sludge fine powder according to the embodiment 2 is explained as shown in FIG. 2. Most of steps are the same as those of the embodiment 1. More specifically, the slurring step S1, the aggregate separating step S2, the fine sand removing step S3 and the dehydration step S4 are the same. Therefore, description of these steps is omitted. A crushing-drying step S11 will be described.

In the production method according to the embodiment 2, a sludge cake is subjected to the crushing-drying step S11. A device used in this step may be of any type only if a sludge cake is dried in a state where the sludge cake is crushed, and the rotary drum used in the production method according to the embodiment 1 can be used. The sludge cake is put into the rotary drum, which is rotated and hot air is supplied. According to this, the sludge cake is crushed by a crushing-stirring blade, the sludge cake is dried by the hot air and sludge fine powder is obtained. In this sludge fine powder, the area fraction of unhydrated cement is 0.5 or more.

The sludge fine powder obtained in this method is subjected to a carbon dioxide fixing step S12, where the sludge fine powder is put into a container having stirring device, highly concentrated carbon dioxide is supplied into the container, and temperature in the container is set to 50° C. or more. If the sludge fine powder is exposed to carbon dioxide while stirring the sludge fine powder for a predetermined time of 30 minutes or more, or one hour or more, the sludge fine powder fixes carbon dioxide. Finally, the carbon dioxide fixing sludge fine powder is obtained.

In the production method according to the embodiment 2, exhaust heat is recovered from the rotary drum in the crushing-drying step S11, and the container may be heated while utilizing the recovered exhaust heat in the carbon dioxide fixing step S12. Utilization of exhaust heat leads to an energy saving correspondingly and also to the reduction of carbon dioxide emission.

### <Properties of Carbon Dioxide Fixing Sludge Fine Powder>

The carbon dioxide fixing sludge fine powder produced by the production methods of the first and the second embodiment steps can be utilized as a binder. When mortar and the like are mixed with the carbon dioxide fixing sludge fine powder as a binder, fluidity becomes higher and workability becomes excellent accordingly as compared with the sludge fine powder without fixing carbon dioxide, i.e., with the step S11 of the embodiment 2. Further, hydraulically hardened body can be obtained using the carbon dioxide fixing sludge fine powder as a binder. The carbon dioxide fixing sludge fine powder not only improves workability as compared with the sludge fine powder but also fixing carbon dioxide. Therefore, it can be said that the carbon dioxide fixing sludge fine powder is low carbon material having small amount of emission of carbon dioxide.

### [Experiment 1]

An experiment was carried out to know how much carbon dioxide the sludge fine powder can fix with the passage of exposure time and to check how quality of the sludge fine powder changes by fixing the carbon dioxide.

### Experimental Method:

To prepare sludge fine powders having different specific surface areas, the production methods S1 to S11 steps for carbon dioxide fixing sludge fine powder of the second embodiment shown in FIG. 2 were carried out for three kinds of residual concretes A, B and C having different time from mixing to the step S1, and sludge fine powder A0, B0 and C0 without carbon dioxide fixation were obtained. The sludge fine powders A0, B0 and C0 were respectively put into containers with a carbon dioxide volume fraction of 0.8, a temperature of 50° C. and carbon dioxide exposure time of 3 hours. Finally, carbon dioxide fixing sludge fine powders A3, B3 and C3 were obtained. Similarly, carbon dioxide fixing sludge fine powders A6, B6, C6, A12, B12, C12, . . . . A24, B24 and C24 with a carbon dioxide exposure time of 6, 12, 18 and 24 hours were obtained.

Specific surface areas and densities of the obtained sludge fine powder A0, B0 and C0 were measured, and fixing amounts (ratios by weight) of the carbon dioxide fixing sludge fine powder (A3 to A24, B3 to B24 and C3 to C24) are shown in Table 1. The specific surface areas and densities of A, B and C represent those of the sludge fine powder A0, B0 and C0 without carbon dioxide fixation.

TABLE 1

| | A | | B | | C | |
|---|---|---|---|---|---|---|
| | Density 2.96 (g/cm3) | | Density 2.59 (g/cm3) | | Density 2.30 (g/cm3) | |
| | Specific surface area | | Specific surface area | | Specific surface area | |
| | 5290 (cm2/g) | | 6790 (cm2/g) | | 10360 (cm2/g) | |
| Exposure time | | Fixing amount | | Fixing amount | | Fixing amount |
| (h) of carbon | | (%) of | | (%) of | | (%) of |
| dioxide | Symbol | carbon dioxide | Symbol | carbon dioxide | Symbol | carbon dioxide |
| No carbonation | A0 | 0.00 | B0 | 0.00 | C0 | 0.00 |
| 3 | A3 | 0.33 | B3 | 1.48 | C3 | 3.07 |
| 6 | A6 | 0.61 | B6 | 1.72 | C6 | 3.10 |
| 12 | A12 | 1.15 | B12 | 2.24 | C12 | 3.68 |
| 18 | A18 | 1.04 | B18 | 2.37 | C18 | 4.03 |
| 24 | A24 | 1.61 | B24 | 2.70 | C24 | 4.09 |

### DISCUSSION

It was confirmed that each of carbon dioxide fixing sludge fine powder, specimens A3 to A24, B3 to B24 and C3 to C24, fixed carbon dioxide and they fixed more as exposure time becomes longer. Regarding the fixation amount of carbon dioxide, as compared on the same exposure time, specimens C3 to C24 showed largest on the basis of C0 with the largest specific surface area before fixation, and the specimens A3 to A24 showed smallest on the basis of A0 with the smallest specific surface area. This is because that cement hydration products formed around particles of unhydrated cement in a form of porous agglomerate, the amount of hydration products becomes larger as the specific surface area becomes larger. In other words, it can be said that as the specific surface area is larger, the number of hydration products is larger. It is considered that since this hydration products fix carbon dioxide, in the case of C0 where the specific surface area is large and the amount of hydration products is also large, the amount of carbon dioxide which is fixed during the same exposure time is large as compared with A0 and B0.

### [Experiment 2]

Regarding the sludge fine powder A0, . . . , and the carbon dioxide fixing sludge fine powder A3, . . . obtained by the experiment of the embodiment 1, experiment for evaluating the performance when utilized as a binder was carried out.

Experimental method:

Using the specimens of sludge fine powder A0, B0 and C0, and the carbon dioxide fixing sludge fine powder A3, B3, . . . , C24 obtained in the experiment of the embodiment 1, mortars were mixed in conformance to JIS R5201 utilizing the specimens as a binder. For the respective mortars, flow in values were measured accordance with JIS R5201. When mortars were hardened, compressive strength at the material age of 28-day was determined. Results are shown in Table 2.

TABLE 2

| | A | | | B | | | C | | |
|---|---|---|---|---|---|---|---|---|---|
| | Density 2.96 (g/cm3) | | | Density 2.59 (g/cm3) | | | Density 2.30 (g/cm3) | | |
| | Specific surface area | | | Specific surface area | | | Specific surface area | | |
| | 5290 (cm2/g) | | | 6790 (cm2/g) | | | 10360 (cm2/g) | | |
| Exposure time | | Mortar | Mortar | | Mortar | Mortar | | Mortar | Mortar |
| (h) of carbon | | flow | strength | | flow | strength | | flow | strength |
| dioxide | Symbol | (mm) | (N/mm2) | Symbol | (mm) | (N/mm2) | Symbol | (mm) | (N/mm2) |
| No carbonation | A0 | 154.0 | 53.3 | B0 | 152.0 | 46.5 | C0 | 116.0 | 29.0 |
| 3 | A3 | 171.5 | 51.4 | B3 | 271.0 | 47.5 | C3 | 250.0 | 31.6 |
| 6 | A6 | 187.5 | 53.0 | B6 | 257.0 | 43.5 | C6 | 210.5 | 32.0 |
| 12 | A12 | 188.0 | 51.8 | B12 | 265.0 | 43.1 | C12 | 220.0 | 30.0 |
| 18 | A18 | 187.5 | 51.0 | B18 | 278.5 | 41.6 | C18 | 222.0 | 24.0 |
| 24 | A24 | 187.0 | 51.8 | B24 | 262.0 | 43.3 | C24 | 232.0 | 22.3 |

### DISCUSSION

Concerning fluidity of mortar, it was confirmed that as exposure time of carbon dioxide increased to 3, 6, . . . , and 24 hours, any of flow values of mortars using the carbon dioxide fixing sludge fine powder A3, A6, . . . , C24 as a binder became large (improved). That is, it was confirmed that if sludge fine powder fix carbon dioxide, workability of mortar using the sludge fine powder as the binder was improved.

The largest variation of the flow value of mortar specimen using a binder of carbon dioxide fixing sludge fine powder C3 to C24 on the basis of C0 where the specific surface area was the largest was confirmed, and the smallest variation of the flow value of mortar with the carbon dioxide fixing sludge fine powder A3 to A24 on the basis of A0 with the smallest specific surface area was confirmed. This is because that in the sludge fine powder A0, B0 and C0 before carbon dioxide is fixed, cement hydration products form a portion around particle of unhydrated cement in a form of porous agglomerate. A large amount of hydration products increases the specific surface area, and most of water in mortar is taken into the hydration products leading to a low fluidity. If carbon dioxide is applied to the sludge fine powder A0, B0 and C0 having low fluidity, the hydration products fix carbon dioxide and calcium carbonate and the like are produced and it becomes difficult to keep water in mortar and therefore fluidity is improved. Therefore, sludge fine powder C0 having the largest specific surface area before carbon dioxide is fixed has a larger amount of hydration product as compared with A0 and B0 and correspondingly, fluidity is poor and the flow value is the smallest. However, in the case of the sludge fine powder C3 to C24 in which carbon dioxide is fixed, as fixing of carbon dioxide proceeds, fluidity is largely improved, and a degree of improvement of the flow value becomes larger. On the contrary, in the case of the sludge fine powder A0 having the smallest specific surface area before carbon dioxide is fixed, since the amount of hydration products is originally small, a degree of improvement of the flow value caused by fixing of carbon dioxide is small.

In any of the A0, B0 and C0, the degree of the improvement of the flow value converges after about six hours of exposure time, and even if the exposure time is increased thereafter, the flow value is not varied almost at all. Here, when a preferable numeric value is considered concerning a flow value of mortar using sludge fine powder as a binder, it is possible to refer to mortar which uses the ordinary portland cement as the binder. When a mortar is produced from the ordinary portland cement, flow value generally becomes 160 mm to 170 mm, but mortar using carbon dioxide fixing sludge fine powder A3, B3, . . . , C24 as binder has a flow value of 170 mm or more, and it can be said that this is a preferable result. From this fact, if the temperature in the container is 50° C. and exposure of carbon dioxide is more than 3 hours, it is possible to obtain carbon dioxide fixing sludge fine powder which can sufficiently be utilized as a binder in terms of fluidity.

### [Experiment 3]

Regarding fixation of carbon dioxide by the sludge fine powder, an experiment was carried out to study how the temperature in the container affect the efficiency of carbon dioxide fixation during exposure.

### Experimental Method:

Regarding a residual concrete D, sludge fine powder DO was obtained in the same method as the experiment of the embodiment 1. The sludge fine powder DO was put into an container and carbon dioxide was fixed in the same manner as the experiment of the embodiment 1. However, the experiment was carried out under the condition that carbon dioxide exposure time e was 1 hour and only temperature in the container at the time of fixing was changed. For 3 patterns in which temperature in the container at the time of fixing was 30° C., 100° C. and 300° C., carbon dioxide fixing sludge fine powder D1-30, D1-100 and D1-300 were obtained respectively. These fine powder D1-30, D1-100 and D1-300 were utilized as a binder, mortar was mixed in accordance with the JIS R5201, and a flow value was measured in accordance with JIS R5201. When mortars were hardened, compressive strength at the material age of 28-day were measured. Concerning these fine powder D1-30, D1-100 and D1-300, fixing amount (fraction by weight), mortar flow value and mortar strength are shown in Table 3. The specific surface area and density of D are for the sludge fine powder DO before carbon dioxide is fixed.

TABLE 3

| | D | | | |
|---|---|---|---|---|
| | Density 2.67 (g/cm3) | | | |
| | Specific surface area 8060(cm2/g) | | | |
| | | | | Mortar |
| Temperature (° C.) | | Amount (%) of | Mortar | compressive |
| at carbon dioxide | | carbon dioxide | flow | strength |
| fixation | Symbol | fixation | (mm) | (N/mm2) |
| No carbonation | D0 | 0.00 | 131.0 | 41.3 |
| 30 | D1-30 | 0.21 | 133.0 | 42.4 |
| 100 | D1-100 | 0.88 | 138.0 | 41.2 |
| 300 | D1-300 | 1.87 | 193.5 | 43.9 |

### DISCUSSION

It is seen from the Table 3 that, as compared under the same exposure time (one hour), as the temperature in the container at the time of carbonation becomes higher, the fixing amount of carbon dioxide becomes larger, and the flow value of the mortar becomes larger. To further study of the mortar flow value, the temperature in the container is expressed on the horizontal axis and a flow value is expressed on the vertical axis, and carbon dioxide fixing sludge fine powder D1-30, D1-100 and D1-300 are plotted as shown in FIG. 5. As seen in the graph, the flow value of the mortar becomes larger as the temperature in the container at the time of carbonation becomes higher. As described above, when the flow value of the mortar using the ordinary portland cement as a binder is referred to, the flow value of the mortar using the sludge fine powder as the binder is 170 mm or more, it is a preferable performance as the binder. Therefore, if the temperature in the container at the time of carbonation is 160° C. or more, a preferable flow value can be obtained. From this point, when carbonation time is as short as 1 hour and carbon dioxide is fixed at the temperature in the container of 160° C. or more, a preferable carbon dioxide fixing sludge fine powder can be obtained.

### INDUSTRIAL APPLICABILITY

The carbon dioxide fixing sludge fine powder according to the embodiments can be used also as a ground improvement material or as solidifier added to fluidized soil.

1. A production method of carbon dioxide fixing sludge fine powder comprising:
a slurrying step of adding water to residual concrete or returned concrete to form a slurry;
a separation step of separating-removing gravel and sand from the slurry to obtain sludge water;
a fine sand removal step of separating-removing fine sand from the sludge water by a wet cyclone to obtain concentrated sludge water;
a dehydration step of dehydrating the concentrated sludge water to obtain a sludge cake; and
a crushing-drying-carbonation step of putting the sludge cake into a rotary drum to supply hot air and highly concentrated carbon dioxide into the rotary drum, and of crushing-drying the sludge cake while fixing the carbon dioxide to obtain the carbon dioxide fixing sludge fine powder; wherein
if only the hot air is supplied into the rotary drum to crush and dry the sludge cake to obtain the sludge fine powder, the sludge fine powder has such quality that area fraction of unhydrated cement to the entire sludge fine powder is 0.5 or more.

2. A production method of carbon dioxide fixing sludge fine powder comprising:
a slurrying step of adding water to residual concrete or returned concrete to form a slurry;
a separating step of separating-removing gravel and sand from the slurry to obtain sludge water;
a fine sand removal step of separating-removing fine sand from the sludge water by a wet cyclone to obtain concentrated sludge water;
a dehydration step of dehydrating the concentrated sludge water to obtain a sludge cake;
a crushing-drying step of putting the sludge cake into a rotary drum to supply hot air into the rotary drum, and of crushing and drying the sludge cake to obtain sludge fine powder; and
a carbon dioxide fixing step of exposing the sludge fine powder to high concentrated carbon dioxide, and of fixing the carbon dioxide to obtain the carbon dioxide fixing sludge fine powder, wherein
the sludge fine powder has such quality that the area fraction of unhydrated cement to the entire sludge fine powder is 0.5 or more.

3. The production method of carbon dioxide fixing sludge fine powder according to claim 2, wherein
exhaust heat generated from the rotary drum is recovered in the crushing-drying step, and
the carbon dioxide fixing step is carried out in a state where the sludge fine powder and the highly concentrated carbon dioxide are stirred and they are heated utilizing the exhaust heat.

4. Carbon dioxide fixing sludge fine powder produced by the production method according to claim 1.

5. A hydraulically hardened body including carbon dioxide fixing sludge fine powder produced by the production method according to claim 1 as at least a portion of the binder.
